(19) United States
(12) Patent Application Publication
(10) Pub. No.: US 2009/0262959 A1
(43) Pub. Date: Oct. 22, 2009

(54) METHOD FOR MANUFACTURING A LOUDSPEAKER HAVING A VOICE COIL ASSEMBLY

(75) Inventors: JIA-HROUNG WU, TAIPEI COUNTY (TW); TAI-YAN KAM, HSINCHU CITY (TW); WEN-CHI FU, HSINCHU CITY (TW); WEN-LAN WU, KAOHSIUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: HSIUPING INSTITUTE OF TECHNOLOGY, TAICHUNG COUNTY (TW)

(21) Appl. No.: 12/104,755

(22) Filed: Apr. 17, 2008

(51) Int. Cl. H04R 19/02

(52) U.S. Cl. 381/191

(57) ABSTRACT

A method for manufacturing a loudspeaker having a voice coil assembly includes the steps of: producing a flat voice coil; placing the voice coil into an injecting mold of a vibrating slab; forming a locating section to secure the voice coil; and assembling a loudspeaker by coupling the vibrating slab with a membrane together to produce a better sound quality. Furthermore, upper suspending arms provided on respective sides of the vibrating slab may be cut to lower the rigidity character of the vibrating slab and to increase the vibrating effect.

### BACKGROUND OF THE INVENTION

1. Field of the Invention

The present invention relates to a method for manufacturing a loudspeaker having a voice coil assembly, and more particularly to a method comprising the steps of placing a flat voice coil into an injecting mold; forming a locating section to secure the voice coil; and assembling the loudspeaker.

2. Description of the Prior Art

A conventional loudspeaker has a cylinder electromagnetic transducer, which is too big in size and may cause inconvenience to the user. As shown in FIG. 5, a conventional voice coil assembly comprises a vibrating slab (A) which is provided with a coil (A1) thereon. The coil (A1) may be a conducting line with a plurality of winding and patterned on a printed circuit board. The top of the vibrating slab (A) has a top board (A2) for a membrane to be glued thereon. An upper suspending arm (A3) and a lower suspending arm (A4) extend from respective sides of the vibrating slab (A) and are connected to a fixture (A5). Along with magnets (not shown) provided on the front and rear of the vibrating slab (A), the vibrating slab (A) will produce a vibration when the coil (A1) is activated with electric power, while the vibrating slab (A) hanging along the upper suspending arms (A3) and the lower suspending arms (A4) will vibrate in a vertical direction, which drives the membrane to vibrate and output the sound. However, because the coil (A1) is glued to the vibrating slab (A), the manufacture requires more time and may be loosened after a period of time usage.

### SUMMARY OF THE INVENTION

According to the present invention, there is provided a method for manufacturing a loudspeaker having a voice coil assembly comprising the steps of: step A. producing a flat voice coil by winding a wire; step B. placing and securing said voice coil in an injecting mold of a vibrating slab; step C. injecting said vibrating slab along with said voice coil together, a locating section being integrally formed and surrounding said voice coil; and step D. assembling a loudspeaker by coupling said vibrating slab with a membrane.

Said vibrating slab in step C comprises a pair of upper suspending arms extending from respective upper sides thereof and a pair of lower suspending arms extending from respective lower sides thereof, the other ends of said upper suspending arms and said lower suspending arms being connected to fixtures, respectively.

Said upper suspending arms of said vibrating slab in step D are cut.

It is the primary object of the present invention to provide a method for manufacturing a loudspeaker having a voice coil assembly, which is easy to make mass production and to lower the cost.

It is another object of the present invention to provide a method for manufacturing a loudspeaker having a voice coil assembly, which provides the locating section surrounding the voice coil to hold the voice coil in a secure way.

It is a further object of the present invention to provide a method for manufacturing a loudspeaker having a voice coil assembly, which provides the flat voice coil located in the vibrating slab with two side areas exposed so as to radiate the heat.

It is still a further object of the present invention to provide a method for manufacturing a loudspeaker having a voice coil assembly, which provides supports to connect with respective ends of the membrane, by removing the upper suspending arms to provide a larger vibration space, the rigidity of the material will be lowered in the vertical direction to output more and better sound quality.

### BRIEF DESCRIPTION OF THE DRAWINGS

FIG. 1 is a block diagram of the present invention;

FIG. 2 is a cross-sectional view of the present invention showing that a voice coil is placed into an injecting mold of a vibrating slab;

FIG. 3 is a perspective view of the present invention showing that the voice coil is integrally formed with the vibrating slab;

FIG. 4 is a side cross-sectional view of the present invention; and

FIG. 5 is a perspective view of the prior art.

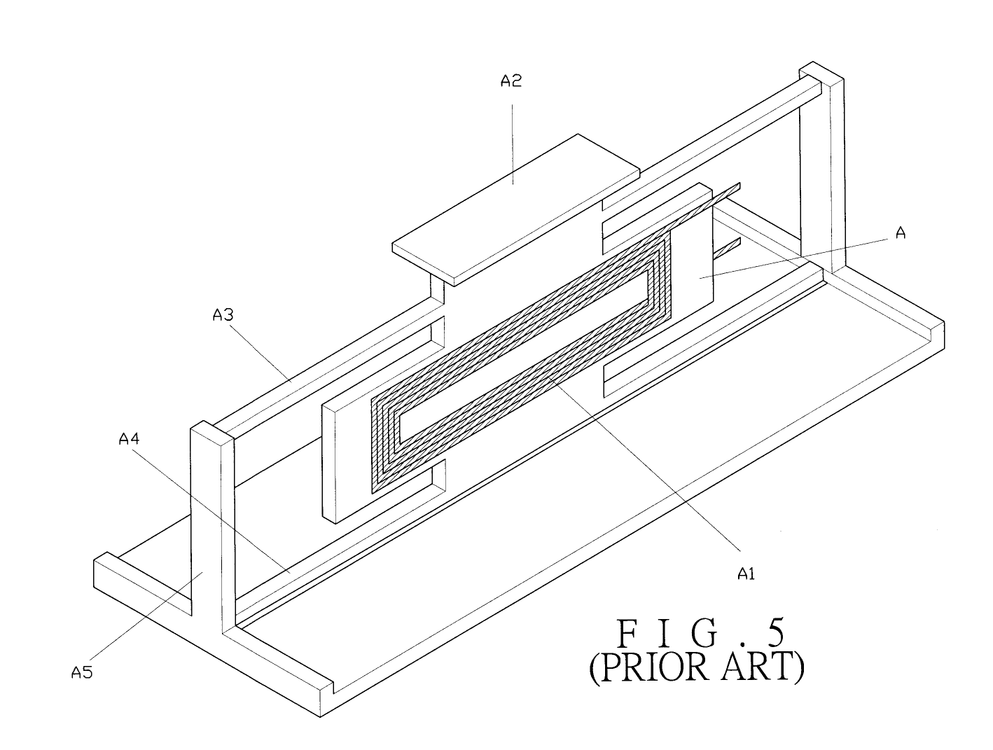

### DETAILED DESCRIPTION OF THE PREFERRED EMBODIMENT

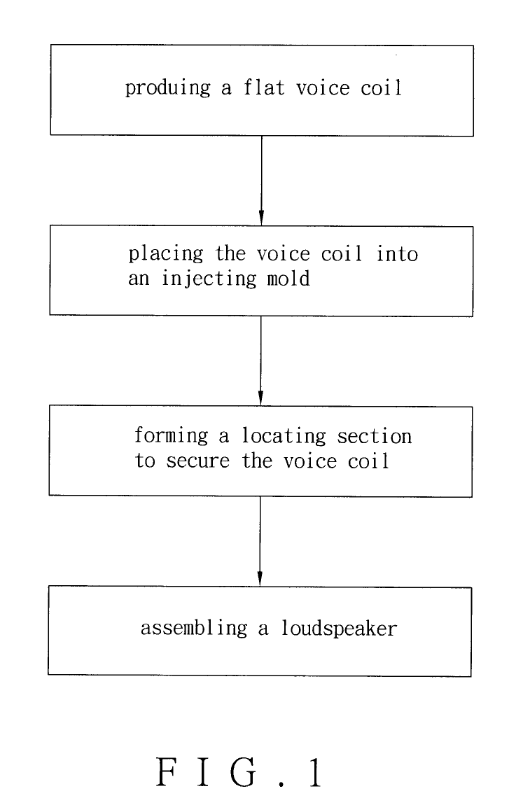

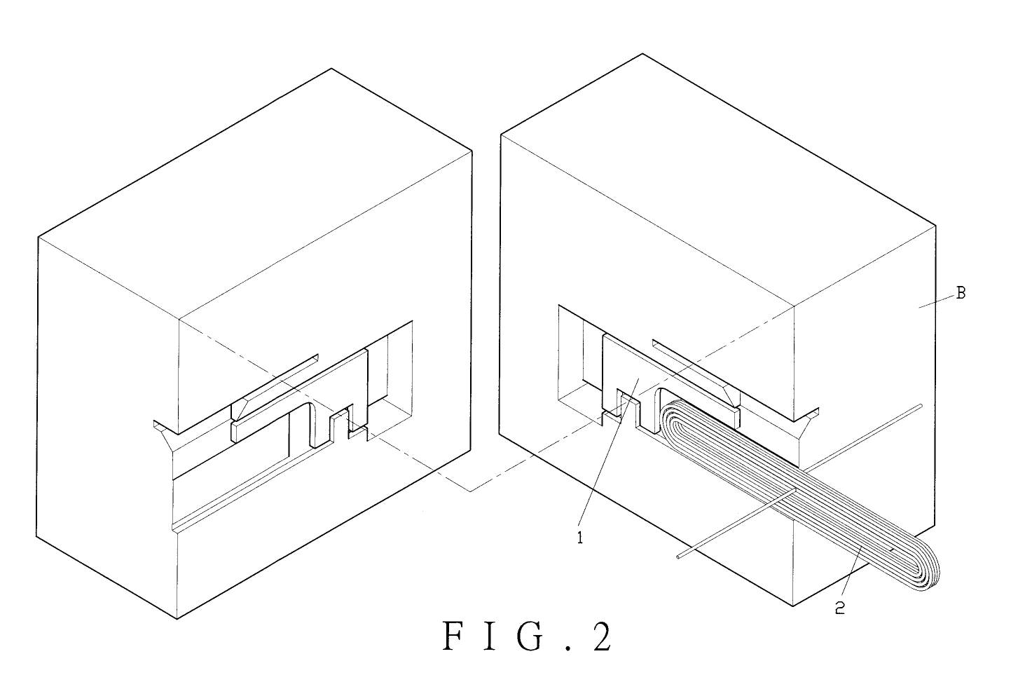

A method for manufacturing a loudspeaker having a voice coil assembly of the present invention, as shown in FIGS. 1 and 2, comprises the steps of:

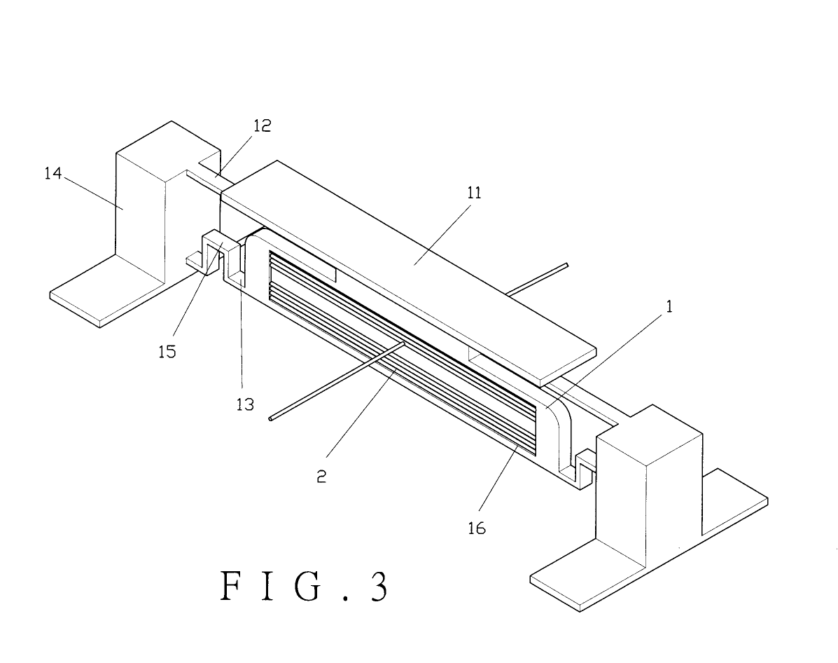

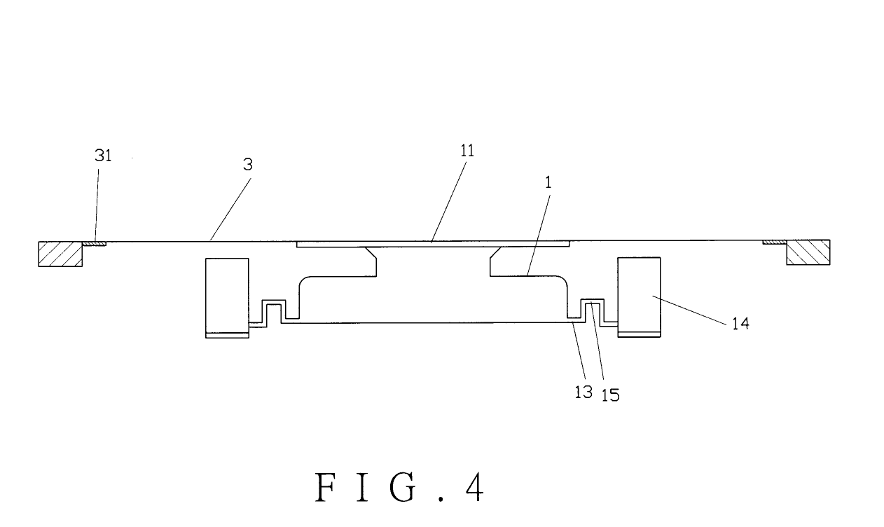

step A. producing a flat voice coil: producing a voice coil (2) in a square flat shape by using a winding apparatus;
step B. placing the voice coil into an injecting mold: placing the voice coil (2) into an injecting mold (B) of a vibrating slab (1);
step C: forming a locating section to secure the voice coil: securing the voice coil (2) to the vibrating slab (1) after being injected from the injecting mold (B) with the voice coil (2) surrounded by a locating section (16) which is integrally formed with the vibrating slab (1), as shown in FIG. 3. The vibrating slab (1) is in a flat shape. A top board (11) is disposed on the top of the vibrating slab (1). The vibrating slab (1) is provided with two upper suspending arms (12) and two lower suspending arms (13) extending from two opposite sides of the vibrating slab (1). The other ends of the upper suspending arms (12) and the lower suspending arms (13) are connected to a pair of fixtures (14), respectively. Between the lower suspending arm (13) and the fixture (14), there is a resilient section (15). The resilient section (15) may be in a reversed U shape, in a regular U shape, in a concave shape, in a convex shape or in a continuous wave shape; and
step D. assembling a loudspeaker: as shown in FIG. 4, the injected vibrating slab (1) along with the top board (11) and a membrane (3) being coupled together, the membrane (3) being connected with supports (31) to assemble a loudspeaker. Another design may also be applied vertically by setting the supports (31) in the front and rear, the left and right sides symmetrically and then cutting the upper suspending arms (12).

When the upper suspending arms (12) on respective sides of the vibrating slab (1) are cut, the supports (31) shall restrict the vibrating slab (1) from moving horizontally but vertically. The elimination of the upper suspending arms (12) lowers the rigidity of the material, meanwhile, the resilient section (15) between the lower suspending arm (13) and the fixture (14) provides more space to vibrate, thus an expanded audio output can be produced. The resilient section (15) of the lower suspending arm (13) is in a wide flat shape, which increases the material rigidity of the vibrating slab (1) from moving horizontally to prevent the vibrating slab (1) from rubbing against magnets. The voice coil (2) which is secured by the locating section (16) is held securely to the vibrating slab (1).

What is claimed is:

1. A method for manufacturing a loudspeaker having a voice coil assembly comprising the steps of:
step A. producing a flat voice coil by winding a wire;
step B. placing and securing said voice coil in an injecting mold of a vibrating slab;
step C. injecting said vibrating slab along with said voice coil together, a locating section being integrally formed and surrounding said voice coil; and
step D. assembling a loudspeaker by coupling said vibrating slab with a membrane.

2. The method according to claim 1, wherein said vibrating slab in step C comprises a pair of upper suspending arms extending from respective upper sides thereof and a pair of lower suspending arms extending from respective lower sides thereof, the other ends of said upper suspending arms and said lower suspending arms being connected to fixtures, respectively.

3. The method according to claim 2, wherein said upper suspending arms of said vibrating slab in step D are cut.
